(19) United States
(12) Patent Application Publication
(10) Pub. No.: US 2026/0230162 A1
(43) Pub. Date: Aug. 6, 2026

(54) PT-RS FOR UL MULTI-BEAM TRANSMISSION SCHEME

(71) Applicant: Google LLC, Mountain View, CA (US)

(72) Inventor: Yushu ZHANG, Beijing (CN)

(21) Appl. No.: 19/150,531

(22) PCT Filed: Feb. 17, 2023
(86) PCT No.: PCT/CN2023/076872

§ 371 Date: Jul. 23, 2025

(51) Int. Cl. H04B 7/06; H04L 27/26

(52) U.S. Cl. CPC H04B 7/06966; H04L 27/261

(57) ABSTRACT

This disclosure provides systems, devices, apparatus, and methods, including computer programs encoded on storage media, for using PT-RS (202) in uplink multi-beam transmission schemes. A UE (102) receives (408a, 808a), from a network entity (104), a configuration for a multi-beam PUSCH transmission. The UE (102) transmits (412, 812), to the network entity (104), the multi-beam PUSCH transmission and a PT-RS based on a number of PT-RS ports and a DMRS port associated with the number of PT-RS ports.

### TECHNICAL FIELD

The present disclosure relates generally to wireless communication, and more particularly, to phase tracking-reference signals (PT-RS) used for uplink multi-beam transmissions.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a phase tracking reference signal (PT-RS) may be implemented for a physical uplink shared channel (PUSCH) transmission, in order to perform phase offset tracking in symbols that do not have demodulation reference signal (DMRS). However, for PUSCH transmissions that use multiple beams, complexities may arise in association with determining which PT-RS ports and which DMRS ports correspond to the different beams of the multi-beam PUSCH transmission.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may transmit a phase tracking reference signal (PT-RS) with a physical uplink shared channel (PUSCH) transmission, so that a network entity, such as a base station or a unit of a base station, can perform phase offset tracking in symbols without demodulation reference signal (DMRS). For example, the network entity compares a phase offset between a PT-RS symbol and a DMRS symbol to estimate and/or compensate for the phase offset, which may be caused by phase noise and/or a frequency offset. The UE can transmit the PT-RS from a single PT-RS port or multiple PT-RS ports.

The UE may determine a number of PT-RS ports for transmitting the PT-RS based on a configuration from the network entity and an indicated precoder. The network entity may also indicate one or more DMRS ports associated with the one or more PT-RS ports, such that the UE can transmit the PT-RS and DMRS using a same precoder for the PT-RS ports(s) and the DMRS port(s). The network entity may schedule the UE to transmit on PUSCH using multiple beams. For example, the network entity transmits two transmission configuration indicators (TCIs) for the PUSCH that configure the UE to transmit with different beams based on spatial domain multiplexing (SDM) techniques or single frequency network (SFN) techniques. However, since the network entity may indicate multiple precoders for the multiple beams, the UE may have to determine which PT-RS ports and DMRS ports correspond to the different beams for the multi-beam transmission.

Aspects of the present disclosure address the above-noted and other deficiencies by configuring the UE to determine the number of PT-RS ports and the associated DMRS port for each of the PT-RS ports for multi-beam transmissions, such as SFN PUSCH transmissions and SDM PUSCH transmissions. The implemented techniques may improve phase offset tracking and estimation/compensation procedures for decoding multi-beam PUSCH transmissions, which may further improve an overall decoding performance.

According to some aspects, the UE receives, from the network entity, a configuration for a multi-beam PUSCH transmission and transmits, to the network entity, the multi-beam PUSCH transmission and a PT-RS based on a number of PT-RS ports and a DMRS port associated with the number of PT-RS ports.

According to some aspects, the network entity transmits, to the UE, the configuration for the multi-beam PUSCH transmission, as described above. The network entity receives, from the UE, the multi-beam PUSCH transmission and the PT-RS based on the number of PT-RS ports and the DMRS port associated with the number of PT-RS ports.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates a diagram of a phase tracking-reference signal (PT-RS) resource mapping.

FIGS. 3A-3B illustrate diagrams for determining a number of PT-RS ports for an uplink transmission.

FIG. 4 illustrates a signaling diagram for PT-RS transmission based on single frequency network (SFN) techniques.

FIG. 5A illustrates a diagram for determining one or more demodulation reference signal (DMRS) ports associated with one or more PT-RS ports.

FIG. 5B illustrates a diagram for precoder re-ordering to provide improved PT-RS and DMRS association.

FIG. 6 illustrates a diagram for determining one or more DMRS ports associated with one or more PT-RS ports.

FIG. 7 illustrates diagrams of example resource mapping patterns for a first beam and a second beam.

FIG. 8 illustrates a signaling diagram for PT-RS transmission based on spatial domain multiplexing (SDM) techniques.

FIG. 9 illustrates diagrams of example resource mapping patterns for a first beam and a second beam.

FIG. 10 illustrates diagrams of example resource mapping patterns for a first beam and a second beam.

FIG. 11 is a flowchart of a method of wireless communication at a UE.

FIG. 12 is a flowchart of a method of wireless communication at a network entity.

FIG. 13 is a diagram illustrating a hardware implementation for an example UE apparatus.

FIG. 14 is a diagram illustrating a hardware implementation for one or more example network entities.

### DETAILED DESCRIPTION

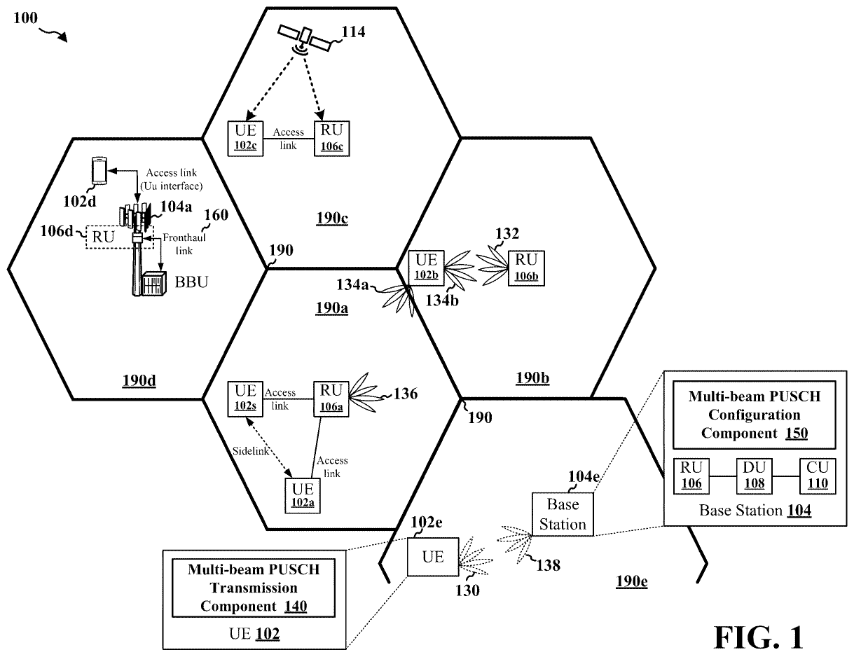

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the RUs 106a-106d may communicate with respective UEs 102a-102d and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104 of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHZ” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHZ, FR4, which ranges from 71.0 GHz-114.25 GHZ, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station/RU 104a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, the UE 102 may include a multi-beam physical uplink shared channel (PUSCH) transmission component 140 configured to receive, from a network entity, a configuration for a multi-beam PUSCH transmission; and transmit, to the network entity, the multi-beam PUSCH transmission and a phase tracking reference signal (PT-RS) based on a number of PT-RS ports and a demodulation reference signal (DMRS) port associated with the number of PT-RS ports.

In certain aspects, the base station 104 or a network entity of the base station 104 may include a multi-beam PUSCH configuration component 150 configured to transmit, to a UE, a configuration for a multi-beam PUSCH transmission; and receive, from the UE, the multi-beam PUSCH transmission and a PT-RS based on a number of PT-RS ports and a DMRS port associated with the number of PT-RS ports.

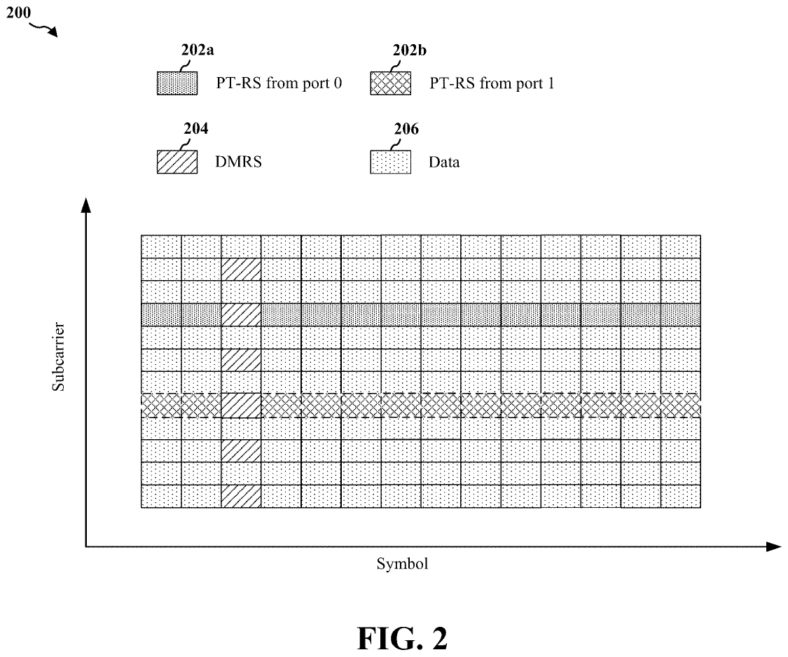

Accordingly, FIG. 1 describes a wireless communication system that may be implemented in connection with aspects of one or more other figures described herein, such as aspects illustrated in FIGS. 2-10. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 illustrates a diagram 200 of a PT-RS resource mapping. A UE and a network entity, such as a base station or a unit of a base station, utilize PT-RS 202 to track the phase of a local oscillator at a receiver and a transmitter. Tracking the phase may enable suppression of phase noise and/or common phase error, such as at high subcarrier frequencies (e.g., millimeter wave (mmW) frequencies). PT-RS 202 may be transmitted by the network entity on downlink, such as on a physical downlink shared channel (PDSCH), or by the UE on uplink, such as on a PUSCH.

When the network entity configures the UE to transmit the PT-RS 202 on the PUSCH, the PT-RS 202 is used as a reference to compensate for errors in symbols without DMRS 204. For example, the diagram 200 illustrates DMRS 204 in the third symbol of a slot, whereas the other 13 symbols of the slot include the PT-RS 202 in at least one subcarrier. The UE can transmit the PT-RS 202 from a single port, such as the PT-RS 202a from port 0, or from multiple ports, such as also with the PT-RS 202b from port 1. The resource elements (REs) of the diagram 200 that are not used for PT-RS 202 and DMRS 204 may include data 206 for PUSCH. The network entity may compare a phase offset between the PT-RS 202 in a symbol and the DMRS 204 in another symbol to estimate and compensate for the phase offset of each symbol, which may be caused by the phase noise and/or a frequency offset.

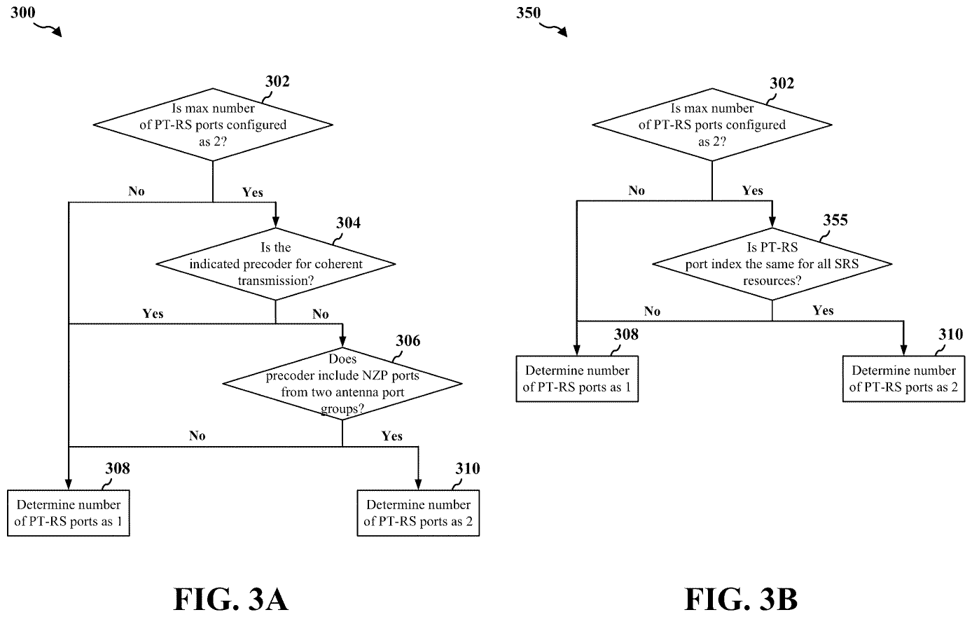

FIGS. 3A-3B illustrate diagrams 300-350 for determining a number of PT-RS ports for an uplink transmission. FIG. 3A applies to codebook-based transmissions, whereas FIG. 3B applies to non-codebook-based transmissions.

The UE may determine 308-310 the number of PT-RS ports based on a configuration from the network entity. The UE can transmit one-port PT-RS or two-port PT-RS based on the configuration. Hence, the UE initially determines 302 whether the maximum number of PT-RS ports is configured as 1 or 2. If the network entity configures the maximum number of PT-RS ports (e.g., maxNrofPorts) in a PTRS-UplinkConfig as 1, the UE transmits the one-port PT-RS based on the determination 308 that the number of PT-RS ports is 1.

For codebook-based transmissions, if the network entity configures the maximum number of PT-RS ports (e.g., maxNrofPorts) in the PTRS-UplinkConfig as 2, the UE determines 304 whether an indicated precoder associated with the configuration is for a partial coherent transmission. If the indicated precoder is for a coherent transmission, the UE transmits the one-port PT-RS based on the determination 308 that the number of PT-RS ports is 1. If the indicated precoder is for a non-coherent transmission or a partial-coherent transmission, the UE determines 306 the number of PT-RS ports based on whether the precoder includes non-zero-power (NZP) ports from two antenna port groups for a PUSCH transmission.

If the NZP ports are not from two different antenna port group, the UE transmits the one-port PT-RS based on the determination 308 that the number of PT-RS ports is 1. If the NZP ports are from two different antenna port groups, the UE transmits the two-port PT-RS based on the determination 310 that the number of PT-RS ports is 2. A first port of the two-port PT-RS corresponds to a first antenna port group and a second port of the two-port PT-RS corresponds to a second antenna port group. In examples for four-port PT-RS, the first and a third port correspond to the first antenna port group and the second and a fourth port correspond to the second antenna port group.

For non-codebook-based transmissions, the UE similarly determines 302 whether the maximum number of PT-RS ports is configured as 1 or 2, and likewise transmits the one-port PT-RS based on the determination 308 that the number of PT-RS ports is 1. However, if the network entity configures the maximum number of PT-RS ports (e.g., maxNrofPorts) in the PTRS-UplinkConfig as 2, the UE determines 355 the number of PT-RS ports based on indicated sounding reference signal (SRS) resources for the non-codebook-based transmission. For example, the UE determines 355 whether a PT-RS port index is the same for all of the indicated SRS resources. If the PT-RS port index is the same for all of the indicated SRS resources, the UE transmits the one-port PT-RS based on the determination 308 that the number of PT-RS ports is 1. If the PT-RS port index for all of the indicated SRS resources are not all the same, the UE transmits the two-port PT-RS based on the determination 310 that the number of PT-RS ports is 2.

The network entity can indicate DMRS port(s) for the PT-RS port(s) via scheduling downlink control information (DCI). For example, the network entity may schedule a PUSCH via DCI and may indicate a PT-RS/DMRS association for the PT-RS port(s). When a PT-RS port is associated with a DMRS port, the UE transmits using the same precoder for the PT-RS port and the DMRS port. Therefore, the network entity may indicate a DMRS port with a best/highest quality precoder among a plurality of DMRS ports that share the same PT-RS port.

The network entity may schedule the UE to transmit on the PUSCH from multiple beams. For example, the network entity indicates two transmission configuration indicators (TCIs) for the PUSCH. That is, the network entity may indicate a first TCI for a first PUSCH and a second TCI for a second PUSCH. The network entity may also configure the UE to transmit on the PUSCH with different beams based on spatial domain multiplexing (SDM) techniques or single frequency network (SFN) techniques.

For the SDM techniques, the UE transmits on the PUSCH with the different beams from different layers. Thus, PUSCH information for each beam is different. For the codebook-based transmission, the network entity uses two DCI fields or configures two radio resource control (RRC) parameters to indicate the precoder for each beam. A first field or parameter indicates the precoder and the number of layers for the first beam, and the second field or parameter indicates the precoder and the number of layers for the second beam. For the non-codebook based transmission, the network entity indicates or configures two sets of SRS resource indicators (SRIs) via DCI or RRC signaling. The UE determines the precoder and the number of layers for the first beam based on a first set of SRIs and the precoder and the number of layers for the second beam based on a second set of SRIs.

For the SFN techniques, the UE transmits based on PUSCH repetitions with different beams. Thus, the PUSCH information for each beam is the same. For the codebook-based transmission, the network entity uses the two DCI fields or configures the two RRC parameters to indicate the precoder for each beam. The first field or parameter indicates the precoder for the first beam and a number of layers for both the first beam and the second beam, and the second field or parameter indicates the precoder for the second beam. For the non-codebook based transmission, the network entity indicates or configures the two sets of SRIs via DCI or RRC signaling. The UE determines the precoder for the first beam and the number of layers for both the first beam and the second beams based on the first set of SRIs and the precoder for the second beam based on the second set of SRIs.

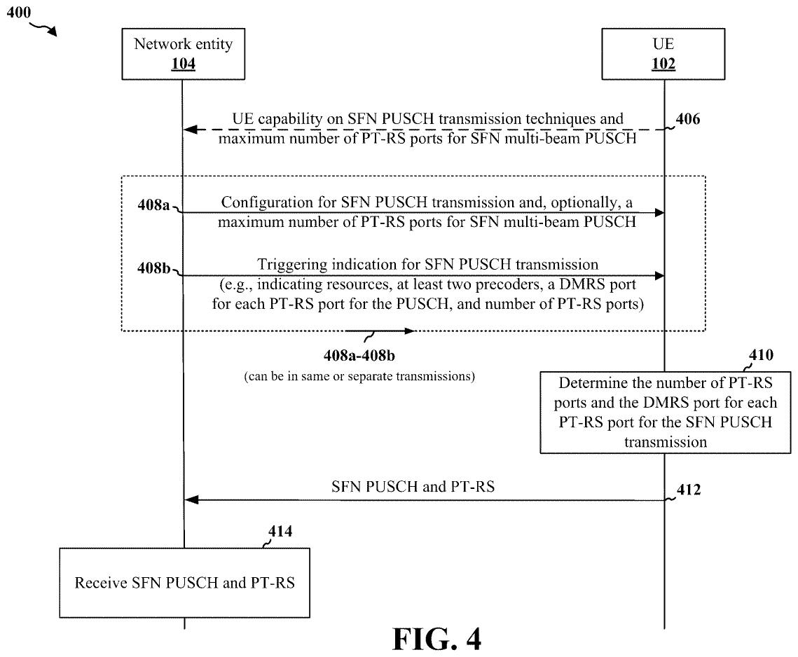

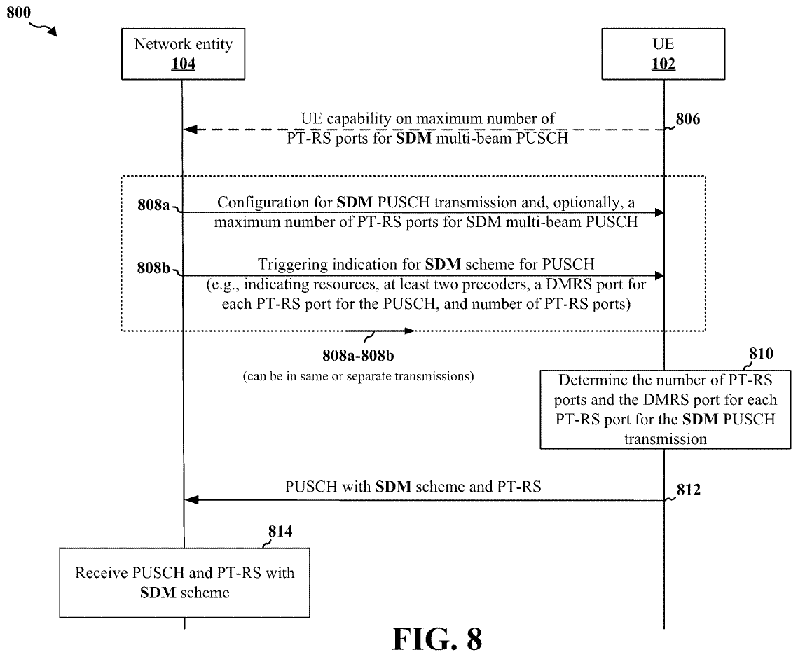

The network entity configures the single-beam or multi-beam based transmission by indicating the SRS resource set(s) for the precoder and the beam indication in the scheduling DCI or RRC signaling. If the network entity indicates one SRS resource set, the UE transmits on the PUSCH based on single-beam transmission scheme. If the network entity indicates more than one SRS resource set, the UE transmits on the PUSCH based on multi-beam transmission (e.g., SDM or SFN techniques). Since the network entity may indicate more than one precoder for more than one beam in a multi-beam transmission, the UE may have to determine the number of PT-RS ports and the associated DMRS port for each PT-RS port for the SFN and/or SDM transmission schemes. PT-RS transmissions on PUSCH for multi-beam procedures may improve phase offset tracking and compensations for decoding the multi-beam PUSCH, which may further improve a decoding performance. FIGS. 2-3B illustrate PT-RS resources and port determinations. FIGS. 4-10 describe PT-RS used for multi-beam PUSCH transmissions. In particular, FIGS. 4-7 describe PT-RS and SFN PUSCH transmission techniques. FIGS. 8-10 describe PT-RS and PUSCH transmission based on SDM techniques.

FIG. 4 illustrates a signaling diagram 400 for PT-RS transmission based on SFN techniques. In some implementations, the UE 102 reports 406, to the network entity 104, a UE capability for an SFN PUSCH transmission and a maximum number of PT-RS ports for an SFN procedure. In other implementations, the network entity 104 receives one or more UE capabilities from a core network (e.g., an access and mobility management function (AMF)). In yet other implementations, the network entity 104 receives the one or more UE capabilities from another base station/network entity (e.g., gNB or eNB). The UE capability may indicate whether the UE 102 supports SFN PUSCH transmissions and/or a supported maximum number of PT-RS ports for the SFN procedure. The UE 102 may report 406 the UE capability per feature set, per band, per band combination, or per UE.

The network entity 104 may configure 408a the UE 102 with one or more parameters through first control signaling (e.g., RRCReconfiguration) that enables the SFN PUSCH transmission. The configuration 408a for the SFN PUSCH transmission may also optionally indicate the maximum number of PT-RS ports for the SFN procedure. RRC signaling may indicate an RRCReconfiguration message from the network entity 104 to the UE 102 or a system information block (SIB), where the SIB may be a traditional type of SIB (e.g., SIB1) or a different SIB (e.g., SIB J, where J corresponds to an integer greater than 21) transmitted by the network entity 104.

The network entity 104 may transmit 408b, to the UE 102, second control signaling (e.g., DCI) including a triggering indication for the SFN PUSCH transmission. The second control signaling may indicate time-domain and frequency-domain transmission resources, at least two precoders, the DMRS port for each PT-RS port for the PUSCH, and/or a number of PT-RS ports. In some implementations, the network entity 104 may transmit 408 the information indicated in the second control signaling by the first control signaling (i.e., within the same control signaling). In other implementations, the network entity 104 transmits 408a-408b separate control signals to the UE 102.

Based on the control signaling received 408 from the network entity 104, the UE 102 determines 410 the number of PT-RS ports and the DMRS port for each PT-RS port for the SFN PUSCH transmission. The UE 102 transmits 412 the SFN PUSCH and the PT-RS to the network entity 104 based on the determined number of PT-RS ports and the associated DMRS port for each PT-RS port. The network entity 104 receives 414 the SFN PUSCH and the PT-RS based on the configuration and the triggering indication transmitted 408 to the UE 102.

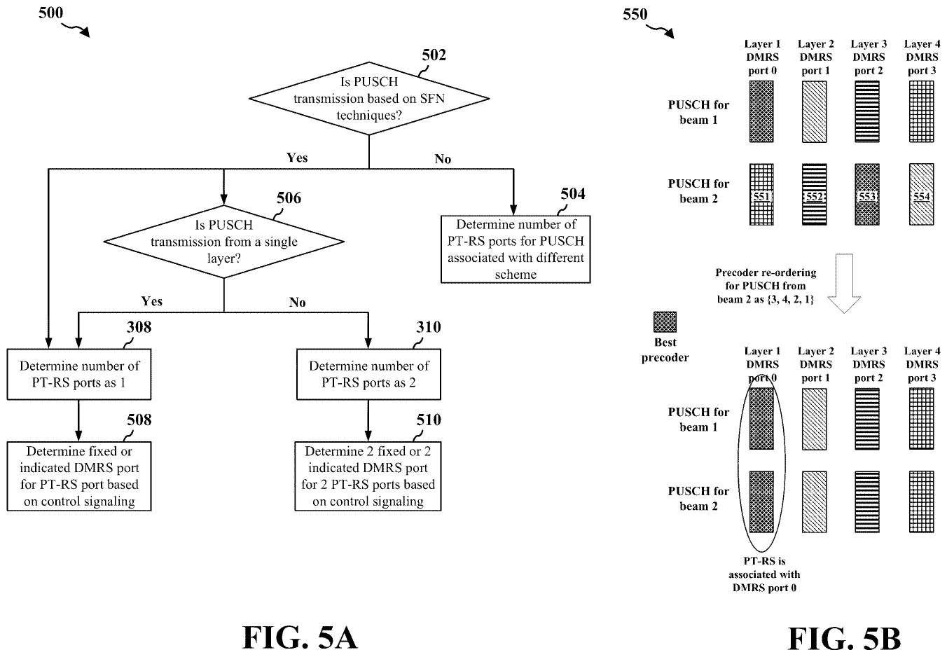

FIG. 5A illustrates a diagram 500 for determining one or more DMRS ports associated with one or more PT-RS ports. The UE can transmit the PT-RS, the DMRS, and data on PUSCH from multiple beams based on SFN techniques. For example, the UE transmits a same PT-RS, DMRS, and PUSCH transmission from each beam with a same resource mapping pattern. Hence, the UE determines 502 whether a PUSCH transmission is based on SFN techniques.

The number of PT-RS ports can be fixed or indicated by the network entity. In examples, the number of PT-RS ports for SFN PUSCH transmission may be fixed as 1, such that the 1 PT-RS port may be associated with a fixed DMRS port (e.g., a first DMRS port). In other examples, the network entity configures or indicates the DMRS port associated with the PT-RS port through control signaling transmitted to the UE. If the UE determines 502 that the PUSCH transmission is not based on SFN techniques, the UE may determine 504 the number of PT-RS ports for the PUSCH associated with the different scheme. Alternatively, as also described with respect to FIG. 4 for SFN PUSCH transmission, if the UE determines 502 that the PUSCH transmission is based on SFN techniques, the UE may determine 308 that the number of PT-RS ports is 1. The UE may further determine 508 the fixed or indicated DMRS port associated with the one PT-RS port based on the control signaling received from the network entity.

In some implementations, the number of PT-RS ports for the SFN PUSCH transmission is fixed as 1 for a single layer PUSCH transmission and fixed as 2 or more for a multi-layer transmission. Thus, if the UE determines 502 that the PUSCH transmission is based on SFN techniques, the UE may further determine 506 whether the PUSCH transmission is for a single layer or multiple layers. If the UE determines 506 that the PUSCH is for a single layer, the UE transmits the PUSCH based on the determinations 308-310 of the PT-RS and DMRS ports. If the UE determines 506 that the PUSCH is for multiple layers, the UE may determine 310 that the number of PT-RS ports is 2, such that the UE may determine 510 2 fixed or 2 indicated DMRS ports associated with the two PT-RS ports based on the control signaling received from the network entity. In some examples, the network entity only configures the SFN PUSCH transmission for up to two layers.

Each PT-RS port may be associated with a fixed DMRS port. In an example for one-port PT-RS, the PT-RS port is associated with the first DMRS port. In another example for two-port PT-RS, a first PT-RS port is associated with the first DMRS port and a second PT-RS is associated with a second DMRS port. The network entity may also configure or indicates the associated DMRS port for each PT-RS port jointly (e.g., through a single DCI field or RRC parameter) or separately (e.g., through two different DCI fields or RRC parameters) via the control signaling transmitted to the UE. The network entity may refrain from indicating precoders for beams that correspond to different numbers of PT-RS ports. For example, the network entity refrains from configuring more than one maximum number of PT-RS ports for the SFN procedure. Accordingly, the network entity configures the maxNrofPorts in PTRS-UplinkConfig as n1 when the network entity configures the SFN PUSCH transmission.

FIG. 5B illustrates a diagram 550 for precoder re-ordering to provide improved PT-RS and DMRS association. Different hatch patterns in the diagram 550 represent different precoders (e.g., precoder 1 551, precoder 2 552, precoder 3 553, and precoder 4 554), where precoder 3 553 corresponds to the best precoder in the example illustrated by the diagram 550. The network entity may configure or indicate a precoder swapping or precoder re-ordering indicator for a first PUSCH beam and/or a second PUSCH beam. The indicator may indicate the precoder order for each layer, such that the network entity is able to provide an SFN DMRS port with a best precoder, which provides the highest receiving power among the precoders applied to all the scheduled DMRS ports.

In the diagram 550, the precoder order for PUSCH beam 2 is re-ordered to align with the precoder order for PUSCH beam 1. That is, the precoder order for PUSCH beam 2 is re-ordered as {3, 4, 2, 1}, so that the best precoder for PUSCH beam 1 and PUSCH beam 2 align with Layer 1 DMRS port 0. As a result, the PT-RS is associated with DMRS port 0. The remaining precoders for PUSCH beam 2 are also re-ordered to align with Layer 2 DMRS port 1, Layer 3 DMRS port 2, and Layer 4 DMRS port 3, respectively.

In some implementations, the network entity transmits a 1-bit indicator that indicates whether the UE should swap the precoder for the first layer and the second layer. In other implementations, the network entity transmits the indicator for indicating the order of the precoders for each layer based on predefined candidate values. In an example for 2-layer transmission, the candidate values for the order of the precoders for the layers may be {1, 2} and {2, 1}. In an example for 3-layer transmission, the candidate values for the order of the precoders for the layers may be {1, 2, 3}, {1, 3, 2}, {2, 1, 3}, {2, 3, 1}, {3, 1, 2}, and {3, 2, 1}. In an example for 4-layer transmission, the candidate values for the order of the precoders for the layers may be arranged in all 24 different possible combinations of the candidate values {1, 2, 3, 4}, including the combination {3, 4, 2, 1}, as illustrated in the diagram 550.

In other implementations, the network entity transmits the indicator for indicating the order of the precoders for each layer based on candidate values configured by the network entity via RRC signaling. The network entity may jointly indicate the precoder ordering indicator and the precoder for a beam using a single indicator. For codebook-based transmission, the codebook may include precoders with different orders, such that the network entity may indicate the precoders with the different orders by indicating different transmission precoder matrix indicators (TPMIs). For non-codebook-based transmission, the network entity may indicate different orders of indicated SRS resources using different values for the fields of the SRIs. For example, an SRI field can indicate SRS resource {1, 2} or {2, 1}.

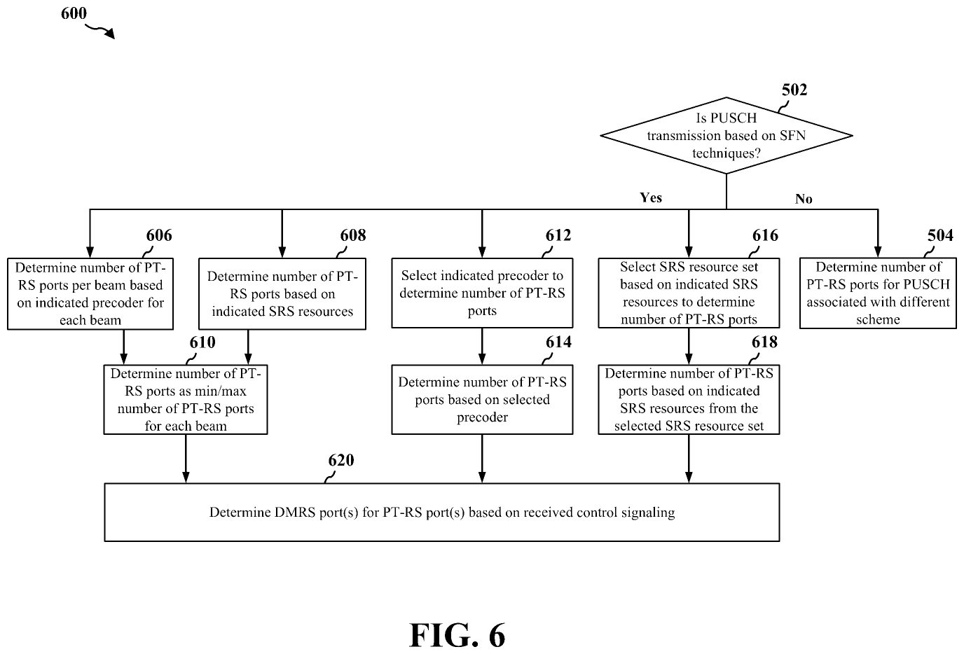

FIG. 6 illustrates a diagram 600 for determining one or more DMRS ports associated with one or more PT-RS ports. Elements 502 and 504 have already been described with respect to FIG. 5A. However, the UE may perform 606, 608, 612, 616 other procedures, if the UE determines 502 that the PUSCH transmission is based on the SFN techniques.

In a first example, for a codebook-based SFN transmission scheme, the UE determines 606 the number of PT-RS ports per beam based on the indicated precoder for each beam. The UE then determines 610 the number of PT-RS ports for the SFN PUSCH transmission as being the minimum or maximum number of PT-RS ports for each beam, such that the UE may further determine 620 the DMRS port(s) for the PT-RS port(s) based on received control signaling (e.g., DCI signaling). If the UE determines that the number of PT-RS ports for a first beam is 1 based on a first indicated precoder and that the number of PT-RS ports for a second beam is 2 based on a second indicated precoder, the UE may determine 610 the number of PT-RS ports for the SFN PUSCH transmission as min {1, 2}=1 or max {1, 2}=2.

In a second example, for a non-codebook-based SFN transmission scheme, the UE determines 608 the number of PT-RS ports based on indicated SRS resources. For instance, the UE may determine 608 the number of PT-RS ports per beam based on the indicated SRS resources for each beam. The determination 608 of the number of PT-RS ports may be based on one of the indicated precoders for the SFN PUSCH transmission. The UE determines 608 the number of PT-RS ports per beam based on the indicated SRS resources for each SRS resource set, such that the UE may determine 610 the number of PT-RS port for the SFN PUSCH transmission as being the minimum or maximum number of PT-RS ports for each beam. The UE further determines 620 the DMRS port(s) for the PT-RS port(s) based on the received control signaling. If PT-RS port indexes for the indicated SRS resources across the SRS resource set are the same, the UE determines that the number of PT-RS ports is 1. Otherwise, the UE may determine that the number of PT-RS ports is 2. In other implementations, after the UE determines 608 the number of PT-RS ports per beam based on the indicated SRS resources for each SRS resource set, the UE may directly determine 620 the DMRS port(s) for the PT-RS port(s) based on the received control signaling.

In a third example, for the codebook-based SFN transmission scheme, the UE selects 612 the indicated precoder to determine the number of PT-RS ports. For instance, the UE may select 612 the indicated precoder for a first beam to determine the number of PT-RS ports for the first beam and select 612 the indicated precoder for a second beam to determine the number of PT-RS ports for the second beam. The determination 614 of the number of PT-RS ports is based on one of the indicated precoders for the SFN PUSCH transmission. The network entity may configure or indicate through control signaling which precoder should be used to determine the number of PT-RS ports. After selecting 612 one of the indicated precoders, the UE determines 614 the number of PT-RS ports based on the selected precoder, such that the UE may further determine 620 the DMRS port(s) for the PT-RS port(s) based on the received control signaling.

In a fourth example, for the non-codebook-based SFN transmission scheme, the UE selects 616 an SRS resource set based on indicated SRS resources to determine the number of PT-RS ports. The UE determines 618 the number of PT-RS ports based on the indicated SRS resources from the selected SRS resource set, such that the UE may further determine 620 the DMRS port(s) for the PT-RS port(s) based on the received control signaling. The UE can identify associated DMRS ports, as described above. The network entity can also configure or indicate an order of the precoders, as described above.

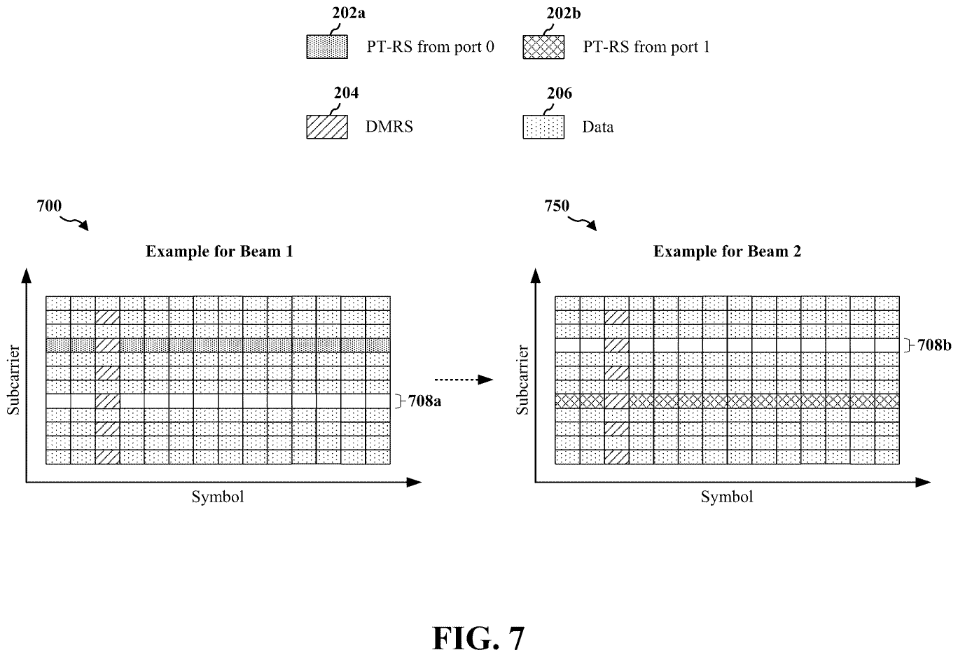

FIG. 7 illustrates diagrams 700-750 of example resource mapping patterns for a first beam and a second beam. The diagram 700 corresponds to a first resource mapping pattern for a first beam. The diagram 750 corresponds to a second resource mapping pattern for a second beam. The UE transmits the PT-RS 202 (e.g., PT-RS 202a from port 0 and PT-RS 202b from port 1) based on non-SFN techniques, but transmits the DMRS 204 and the data 206 for the PUSCH with multiple beams based on SFN techniques. That is, the UE transmits the different PT-RSs 202a/202b with different beams (e.g., PT-RS 202a on beam 1 and PT-RS 202b on beam 2) and transmits the DMRS 204 and the data 206 on multiple beams (e.g., beam 1 and beam 2) with a same resource mapping pattern. In other implementations, the UE may also transmit the DMRS 204 based on non-SFN techniques. The number of PT-RS ports for each beam may be predefined (e.g., the number of PT-RS port for each beam may be fixed as 1). Non-SFN transmission techniques for the PT-RS 202 may cause some REs 708a/708b for each beam to be empty that may otherwise have been used for an additional PT-RS 202 in an SFN procedure.

The network entity may indicate a common DMRS port index to the UE to associate the DMRS port for each beam with the PT-RS port for each beam based on an indicator in the control signaling. In some implementations, the network entity indicates the PT-RS port for each beam associated with either a first DMRS port or a second DMRS port applied to the beam. The network entity may further configure a precoder re-ordering indicator for one or more indicated precoders.

The network entity associates different DMRS ports for each beam with the PT-RS port for each beam using a joint indicator or separate indicators. The joint indicator for the PT-RS ports for a multi-beam transmission may be associated with up to 2 layers. For example, the joint indicator includes 2 bits, where a first bit indicates whether the PT-RS 202 for the first beam is associated with a first DMRS port or a second DMRS port applied to the first beam, and a second bit indicates whether the PT-RS 202 for the second beam is associated with the first DMRS port or the second DMRS port applied to the second beam. In another example with separate indicators for the PT-RS ports for a multi-beam transmission (e.g., with up to 2 layers), each of the separate indicators may include 1 bit that indicates whether the PT-RS 202 for a beam is associated with the first DMRS port or the second DMRS port applied to the beam.

The DMRS port for the PT-RS 202 in each beam may be predefined. The UE may transmit the PT-RS 202 in each beam via power boosting. For example, the UE can transmit the PT-RS 202 with X dB power boosting, such that an energy per resource element (EPRE) ratio between the PT-RS 202 and the PUSCH is X dB. X may be predefined (e.g., X=10 log₁₀ K, where K corresponds to the number of indicated beams). The network entity may configure the value of X through the control signaling. In some examples, the UE reports a supported or preferred value of X to the network entity in the UE capability report.

The network entity may indicate K*N DMRS ports for the PUSCH, where N corresponds to the number of layers and K corresponds to the number of indicated beams. A DMRS port grouping for each beam may be predefined. For example, if the UE transmits on the PUSCH using two beams, the UE can transmit on the PUSCH using the first beam for the first N DMRS ports and the second beam for a remainder of the N DMRS ports. The network entity may configure or indicate the DMRS port grouping for each beam through the control signaling. In examples, the network entity indicates the DMRS port grouping and the DMRS ports jointly.

The DMRS port and DMRS port grouping indication for a rank 2 SFN PUSCH transmission for two beams with non-SFN DMRS may be based on the following table:

| | Number of DMRS CDM | | DMRS port(s) |
|---|---|---|---|
| Value | group(s) without data | DMRS port(s) | grouping |
| 0 | 2 | 0, 1, 2, 3 | {0, 1}, {2, 3} |
| 1 | 2 | 0, 1, 2, 3 | {0, 2}, {1, 3} |
| 2 | 2 | 0, 1, 2, 3 | {0, 3}, {1, 2} |
| 3-7 | Reserved | Reserved | Reserved |

A Type 1 DMRS (e.g., dmrs-Type=1) may include 1 front-loaded symbol (e.g., maxLength=1). The UE may transmit the PT-RS 202, the data 206 on the PUSCH, and the DMRS 204 for each beam based on the same transmission power. The network entity may configure a transmission power ratio for the PT-RS 202, the data 206 on the PUSCH, and the DMRS 204 for each beam through the control signaling. The UE may report the transmission power ratios to the network entity via the UE capability report, a medium access control-control element (MAC-CE), uplink control information (UCI), or based on UE-assistance information.

The network entity may configure or indicate whether to determine the number of PT-RS ports based on a plurality of indicated precoders (e.g., all the indicted precoders) or based on one of the indicated precoders. The network entity may also configure or indicate through the control signaling whether to determine the number of PT-RS ports based on a predefined number of PT-RS ports. The UE may transmit the PT-RS 202 and the DMRS 204 based on SFN or non-SFN techniques. The UE may report a UE capability to the network entity, indicating whether the UE supports determining the number of PT-RS ports based on the indicated precoders or based on a predefined number of PT-RS ports. The UE may also report a UE capability to the network entity, indicating whether the UE supports transmission of the PT-RS 202 and the DMRS 204 based on the SFN or non-SFN techniques. The network entity may configure the UE to transmit the PT-RS 202 and the PUSCH based on the UE capability report. FIGS. 4-7 describe PT-RS and SFN PUSCH transmission techniques. FIGS. 8-10 describe PT-RS and PUSCH transmission based on SDM techniques.

FIG. 8 illustrates a signaling diagram 800 for PT-RS transmission based on SDM techniques. In some implementations, the UE 102 reports 806, to the network entity 104, a UE capability for an SDM PUSCH transmission and a maximum number of PT-RS ports for an SDM procedure. In other implementations, the network entity 104 receives one or more UE capabilities from a core network (e.g., an AMF). In yet other implementations, the network entity 104 receives the one or more UE capabilities from another base station/network entity (e.g., gNB or eNB). The UE capability may indicate whether the UE 102 supports SDM PUSCH transmissions, a supported maximum number of PT-RS ports for the SDM procedure, and/or whether the two indicated beams share the same PT-RS port or different PT-RS ports. The UE 102 may report 806 the UE capability per feature set, per band, per band combination, or per UE.

The network entity 104 may configure 808a the UE 102 with one or more parameters through first control signaling (e.g., RRCReconfiguration) that enables the SDM PUSCH transmission. The configuration 808a for the SDM PUSCH transmission may also optionally indicate the maximum number of PT-RS ports for the SDM procedure. RRC signaling may indicate an RRCReconfiguration message from the network entity 104 to the UE 102 or a SIB, where the SIB may be a traditional type of SIB (e.g., SIB1) or a different SIB (e.g., SIB J, where J corresponds to an integer greater than 21) transmitted by the network entity 104.

The network entity 104 may transmit 808b, to the UE 102, second control signaling (e.g., DCI) including a triggering indication for the SDM PUSCH transmission. The second control signaling may indicate time-domain and frequency-domain transmission resources, at least two precoders, the DMRS port for each PT-RS port for the PUSCH, and/or the number of PT-RS ports. In some implementations, the network entity 104 may transmit 808 the information indicated in the second control signaling by the first control signaling (i.e., within the same control signaling). In other implementations, the network entity 104 transmits 808a-808b separate control signals to the UE 102.

Based on the control signaling received 808 from the network entity 104, the UE 102 determines 810 the number of PT-RS ports and the DMRS port for each PT-RS port for the SDM PUSCH transmission. The UE 102 transmits 812 the SDM PUSCH and the PT-RS to the network entity 104 based on the determined number of PT-RS ports and the associated DMRS port for each PT-RS port. The network entity 104 receives 814 the SDM PUSCH and the PT-RS based on the configuration and the triggering indication transmitted 808 to the UE 102.

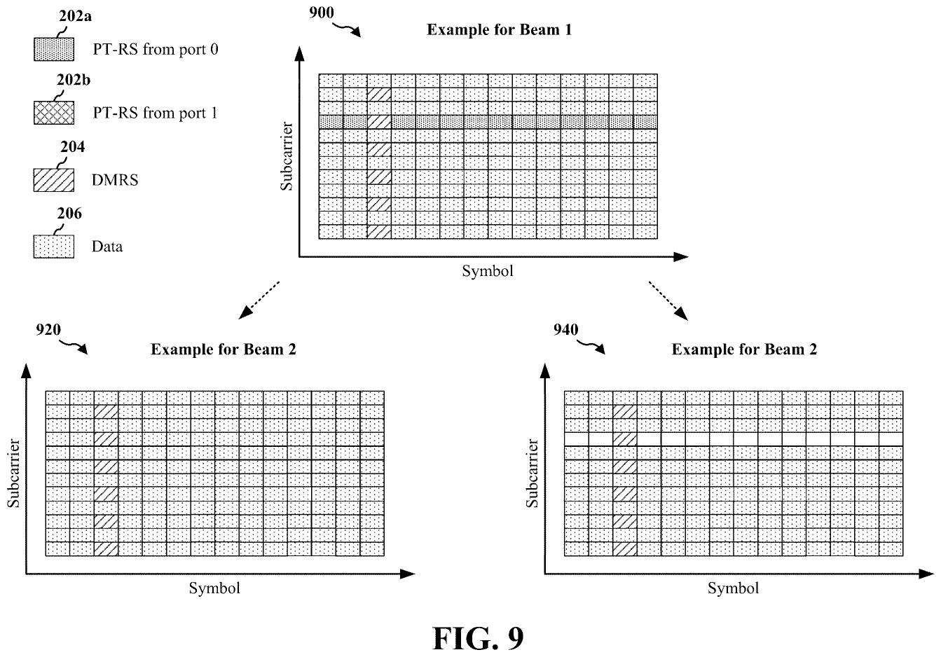

FIG. 9 illustrates diagrams 900-940 of example resource mapping patterns for a first beam and a second beam. The UE may transmit PT-RS 202 from a single port (e.g., PT-RS 202a from port 0) for beam 1 and transmit DMRS 204 and data 206 from different layers for multiple beams (e.g., beam 1 and beam 2). The example resource mapping may apply to UEs that support 1 port PT-RS for a multi-beam PUSCH. The UE may transmit the PT-RS 202 in association with a predefined DMRS port corresponding to the first indicated beam. In other implementations, the network entity transmits control signaling to the UE to configure or indicate the DMRS port associated with the PT-RS 202. An example PT-RS/DMRS port association for 1-port uplink PT-RS 202 for an SDM PUSCH transmission may be based on the following table, where the network entity can indicate the associated DMRS port for the PT-RS port 0, and the DMRS port is selected from the DMRS port(s) scheduled by the control signaling used to schedule the PUSCH:

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

An example PT-RS/DMRS port association for 1-port uplink PT-RS 202 for an SDM PUSCH transmission with the first beam being indicated by first SRI(s) or an SRS resource set may be based on the following table:

| Value | DMRS port |
|---|---|
| 0 | 1^{st} scheduled DMRS port is associated with the |
| | SRI field and/or a precoding information and |
| | number of layers field (e.g., for the first beam) |
| 1 | 2^{nd} scheduled DMRS port is associated with the |
| | SRI field and/or a precoding information and |
| | number of layers field (e.g., for the first beam) |

The UE may transmit the PT-RS 202a, the DMRS 204, and the data 206 on PUSCH in the first beam, as illustrated in the diagram 900, but transmit the data 206 on PUSCH in the second beam at the REs used for the PT-RS 202a in the first beam, as illustrated in the diagram 920, in addition to the other REs that are used for the data 206 on PUSCH. In other examples, the UE may transmit the PT-RS 202a, the DMRS 204, and the data 206 on PUSCH in the first beam, as illustrated in the diagram 900 and transmit, in addition to the DMRS 204, the data 206 on PUSCH in the second beam, as illustrated in the diagram 940, at only the same REs as used for the data 206 on PUSCH for the first beam. That is, the UE does not transmit data 206 or PT-RS 202 in the diagram 940 at the same REs as the UE transmitted the PT-RS 202a in the diagram 900. The network entity may configure or indicate through control signaling whether the REs used for the PT-RS 202a for the first beam are available or unavailable for PUSCH rate matching in the second beam. In some implementations, the UE indicates to the network entity in a UE capability report whether the REs used for the PT-RS 202a for the first beam are available or unavailable for PUSCH rate matching in the second beam.

The network entity may transmit control signaling that configures a power boosting ratio for the PT-RS 202. For example, the network entity configures the EPRE ratio between the PT-RS 202 and the data 206 on PUSCH associated the same SRI(s) or SRS resource set. An example EPRE ratio configuration between the PT-RS 202 and the data 206 on PUSCH for a same beam may be based on the following table:

| | | $The number of PUSCH layers ( {n}_{layer}^{PUSCH} )$ | |
|---|---|---|---|
| | 1 | 2 | |
| UL PT-RS $power / {α}_{PTRS}^{PUSCH}$ | All cases | Full coherent | Partial and non- coherent and non-codebook based |
| 00 | 0 | 3 | 0 |
| 01 | 0 | 3 | 3 |

| | |
|---|---|
| 10 | Reserved |
| 11 | Reserved |

The power boosting ratio for the PT-RS 202 may be predefined. The EPRE ratio between the PT-RS 202 and the data 206 on PUSCH for the same SRI(s) or SRS resource set may also be predefined values corresponding to the above table.

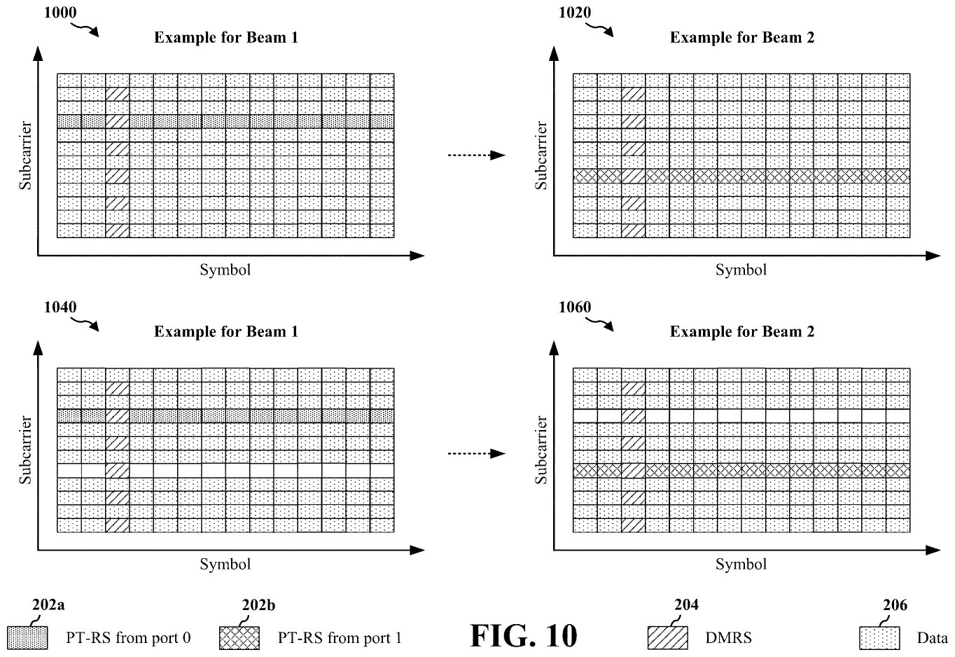

FIG. 10 illustrates diagrams 1000-1060 of example resource mapping patterns for a first beam and a second beam. The UE may transmit PT-RS 202 from multiple ports (e.g., PT-RS 202a from port 0 and PT-RS 202b from port 1), where different PT-RS ports correspond to different beams. The UE transmits the DMRS 204 and data 206 on different layers for the multiple beams. The example resource mappings may apply to UEs that support more than 1-port PT-RS (e.g., 2-port PT-RS) for a multi-beam PUSCH transmission.

The PT-RS ports for the beams may be associated with predefined DMRS ports for the beams. In other examples, the network entity configures or indicates the DMRS ports for each PT-RS port separately or jointly through control signaling. An example DMRS port association indication for 2-port uplink PT-RS 202 for an SDM PUSCH transmission with two SRIs or SRS resource sets may be based on the following table:

| Value of | | | |
|---|---|---|---|
| Most | | Value of | |
| Significant | | Last | |
| Bit | | Significant | |
| (MSB) | DMRS port | Bit (LSB) | DMRS port |
| 0 | 1^{st} scheduled DMRS port | 0 | 1^{st} scheduled DMRS |
| | corresponds to first SRI | | port corresponds to |
| | field and/or a precoding | | second SRI field |
| | information and number | | and/or a second |
| | of layers field (e.g., for | | precoding information |
| | first beam) | | and number of layers |
| | | | field (e.g., for second |
| | | | beam) |
| 1 | 2^{nd} scheduled DMRS | 1 | 2^{nd} scheduled DMRS |
| | port corresponds to first | | port corresponds to |
| | SRI field and/or a first | | second SRI field |
| | precoding information | | and/or a second |
| | and number of layers | | precoding |
| | field (e.g., for first beam) | | information and |
| | | | number of layers |
| | | | field (e.g., for |
| | | | second beam) |

The UE may transmit the data 206 on PUSCH in the second beam, as illustrated in the diagram 1020, at the same REs used for the PT-RS 202a in the first beam, as illustrated in the diagram 1000, and vice versa (e.g., the UE can transmits the data 206 on PUSCH in the first beam, as illustrated in the diagram 1000, at the same REs used for the PT-RS 202b in the second beam, as illustrated in the diagram 1000). In other implementations, the UE transmits the data 206 on PUSCH in the second beam, as illustrated in the diagram 1060, at only the REs used for the data 206 on PUSCH in the first beam, as illustrated in the diagram 1040, and vice versa. The UE determines that the REs for the PT-RS 202 in one beam is not available for data 206 on PUSCH in the other beam. Hence, the UE does not transmit data 206 in the diagram 1040 at the REs that correspond to the PT-RS 202b in the diagram 1060. The UE likewise does not transmit data 206 in the diagram 1060 at the REs that correspond to the PT-RS 202a in the diagram 1040.

The UE may transmit the PT-RS 202 based on K predefined DMRS ports. For example, a first indicated DMRS port of a plurality of DMRS ports corresponds to each indicated beams, where K corresponds to the number of indicated beam(s), the number of SRIs, or the number of precoders. The network entity may configure or indicate the associated DMRS ports for the PT-RS 202 through control signaling. An example DMRS port association indication for 1-port uplink PT-RS 202 for an SDM PUSCH transmission may be based on the following table:

| Value | DMRS port |
|---|---|
| 0 | 1^{st} scheduled DMRS port corresponds to first SRI field and/or |
| | first precoding information and number of layers field (e.g., |
| | for first beam) and 1^{st} scheduled DMRS port corresponds to a |
| | second SRI field and/or a second precoding information and |
| | number of layers field (e.g., for second beam) |
| 1 | 1^{st} scheduled DMRS port corresponds to first SRI field and/or |
| | first precoding information and number of layers field (e.g., |
| | for first beam) and 2^{nd} scheduled DMRS port corresponds to |
| | second SRI field and/or second precoding information and |
| | number of layers field (e.g., for second beam) |
| 2 | 2^{nd} scheduled DMRS port corresponds to first SRI field and/or |
| | first precoding information and number of layers field (e.g., |
| | for first beam) and 1^{st} scheduled DMRS port corresponds to |
| | second SRI field and/or second precoding information and |
| | number of layers field (e.g., for second beam) |
| 3 | 2^{nd} scheduled DMRS port corresponds to first SRI field and/or |
| | first precoding information and number of layers field (e.g., |
| | for first beam) and 2^{nd} scheduled DMRS port corresponds to |
| | second SRI field and/or second precoding information and |
| | number of layers field (e.g., for second beam) |

In some implementations, the UE transmits the PT-RS 202 based on a same sequence at the same REs for both beams. For instance, the UE may repeat a resource mapping pattern for beam 1, such as repeating the resource mapping pattern of the diagram 1000, for both beam 1 and beam 2 based on the PT-RS sequence and the REs for beam 1. The UE determines the PT-RS sequence and the REs based on one of the associated DMRS port. The UE transmits the PT-RS 202 for each beam based on a same precoder as used for the DMRS port for the same beam. The UE may also transmit the PT-RS 202 based on the EPRE being the same across both beams.

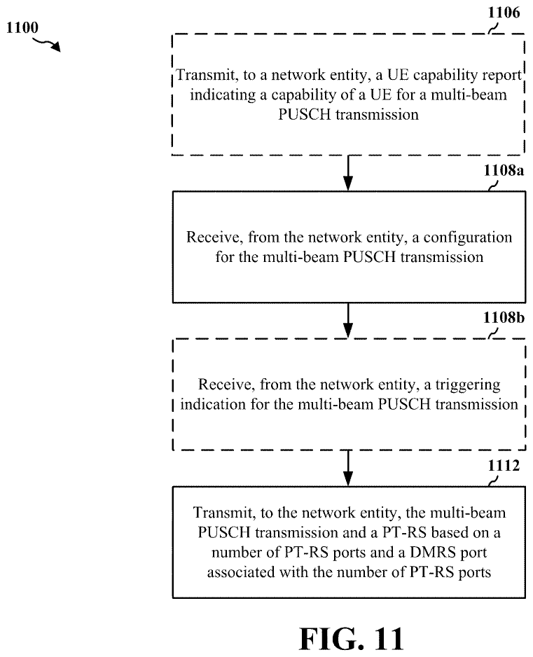

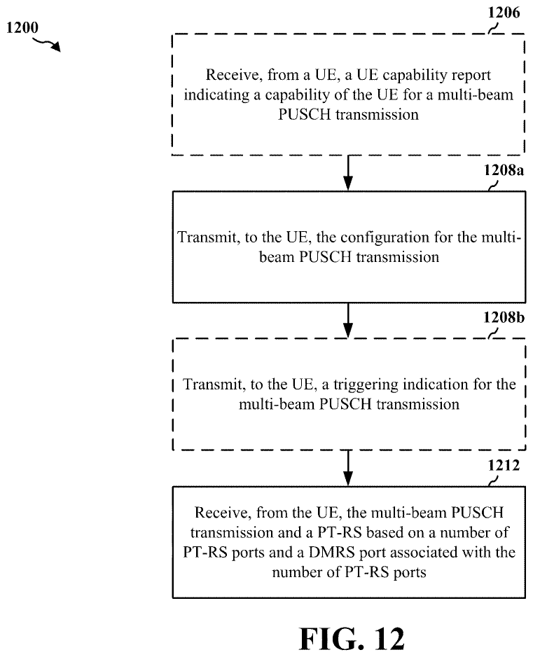

The network entity may configure or indicate through control signaling the number of PT-RS ports for the SDM PUSCH transmission. For single-port PT-RS, the network entity may further configure or indicate whether the PT-RS 202 is transmitted based on SDM techniques or non-SDM scheme for the UE to determine how to transmit the PT-RS 202. The UE may also report to the network entity a UE capability indicating a supported number of PT-RS ports for SDM PUSCH transmission. For single-port PT-RS, the UE may further report a UE capability indicating whether the supports the PT-RS based on the SDM techniques or the non-SDM techniques for the network entity to configure the UE to transmit the PT-RS 202. FIGS. 4-10 describe multi-beam PUSCH transmission techniques. FIGS. 11-12 show methods for implementing one or more aspects of FIGS. 4-10. In particular, FIG. 11 shows an implementation by the UE 102 of the one or more aspects of FIGS. 4-10. FIG. 12 shows an implementation by the network entity 104 of the one or more aspects of FIGS. 4-10.

FIG. 11 illustrates a flowchart 1100 of a method of wireless communication at a UE. With reference to FIGS. 4, 8, and 13, the method may be performed by the UE 102, the UE apparatus 1302, etc., which may include the memory 1326′, 1306′, 1316, and which may correspond to the entire UE 102 or the entire UE apparatus 1302, or a component of the UE 102 or the UE apparatus 1302, such as the wireless baseband processor 1326 and/or the application processor 1306.

The UE 102 transmits 1106, to a network entity, a UE capability report indicating a capability of a UE for a multi-beam PUSCH transmission. For example, referring to FIG. 4, the UE 102 transmits 406, to the network entity 104, a UE capability on SFN PUSCH transmission techniques and a maximum number of PT-RS ports for an SFN multi-beam PUSCH. Referring to FIG. 8, the UE 102 transmits 806, to the network entity 104, a UE capability on a maximum number of PT-RS ports for an SDM multi-beam PUSCH.

The UE 102 receives 1108a, from the network entity, a configuration for the multi-beam PUSCH transmission. For example, referring to FIG. 4, the UE 102 receives 408a, from the network entity 104, a configuration for the SFN PUSCH transmission and, optionally, the maximum number of PT-RS ports for the SFN multi-beam PUSCH. Referring to FIG. 8, the UE 102 receives 808a, from the network entity 104, a configuration for an SDM PUSCH transmission and, optionally, the maximum number of PT-RS ports for the SDM multi-beam PUSCH.

The UE 102 receives 1108b, from the network entity, a triggering indication for the multi-beam PUSCH transmission. For example, referring to FIG. 4, the UE 102 receives 408b, from the network entity 104, a triggering indication for the SFN PUSCH transmission (e.g., indicating resources, at least two precoders, a DMRS port for each PT-RS port for the PUSCH, and/or a number of PT-RS ports). Referring to FIG. 8, the UE 102 receives 808b, from the network entity 104, a triggering indication for an SDM scheme for PUSCH (e.g., indicating resources, at least two precoders, a DMRS port for each PT-RS port for the PUSCH, and/or a number of PT-RS ports).

The UE 102 transmits 1112, to the network entity, the multi-beam PUSCH transmission and a PT-RS based on a number of PT-RS ports and a DMRS port associated with the number of PT-RS ports. For example, referring to FIG. 4 and as illustrated in FIG. 7, the UE 102 transmits 412, to the network entity 104, an SFN PUSCH and a PT-RS 202. Referring to FIG. 8 and as illustrated in FIGS. 9-10, the UE 102 transmits 812, to the network entity 104, a PUSCH with the SDM scheme and a PT-RS 202. FIG. 11 describes a method from a UE-side of a wireless communication link, whereas FIG. 12 describes a method from a network-side of the wireless communication link.

FIG. 12 is a flowchart 1200 of a method of wireless communication at a network entity. With reference to FIGS. 4, 8, and 14, the method may be performed by one or more network entities 104, which may correspond to a base station or a unit of the base station, such as the RU 106, the DU 108, the CU 110, an RU processor 1406, a DU processor 1426, a CU processor 1446, etc. The one or more network entities 104 may include memory 1406′/1426′/1446′, which may correspond to an entirety of the one or more network entities 104, or a component of the one or more network entities 104, such as the RU processor 1406, the DU processor 1426, or the CU processor 1446.

The network entity 104 receives 1206, from a UE, a UE capability report indicating a capability of the UE for a multi-beam PUSCH transmission. For example, referring to FIG. 4, the network entity 104 receives 406, from the UE 102, a UE capability on SFN PUSCH transmission techniques and a maximum number of PT-RS ports for an SFN multi-beam PUSCH. Referring to FIG. 8, the network entity 104 receives 806, from the UE 102, a UE capability on a maximum number of PT-RS ports for an SDM multi-beam PUSCH.

The network entity 104 transmits 1208a, to the UE, the configuration for the multi-beam PUSCH transmission. For example, referring to FIG. 4, the network entity 104 transmits 408a, to the UE 102, a configuration for the SFN PUSCH transmission and, optionally, the maximum number of PT-RS ports for the SFN multi-beam PUSCH. Referring to FIG. 8, the network entity 104 transmits 808a, to the UE 102, a configuration for an SDM PUSCH transmission and, optionally, the maximum number of PT-RS ports for the SDM multi-beam PUSCH.

The network entity 104 transmits 1208b, to the UE, a triggering indication for the multi-beam PUSCH transmission. For example, referring to FIG. 4, the network entity 104 transmits 408b, to the UE 102, a triggering indication for the SFN PUSCH transmission (e.g., indicating resources, at least two precoders, a DMRS port for each PT-RS port for the PUSCH, and/or a number of PT-RS ports). Referring to FIG. 8, the network entity 104 transmits 808b, to the UE 102, a triggering indication for an SDM scheme for PUSCH (e.g., indicating resources, at least two precoders, a DMRS port for each PT-RS port for the PUSCH, and/or a number of PT-RS ports).

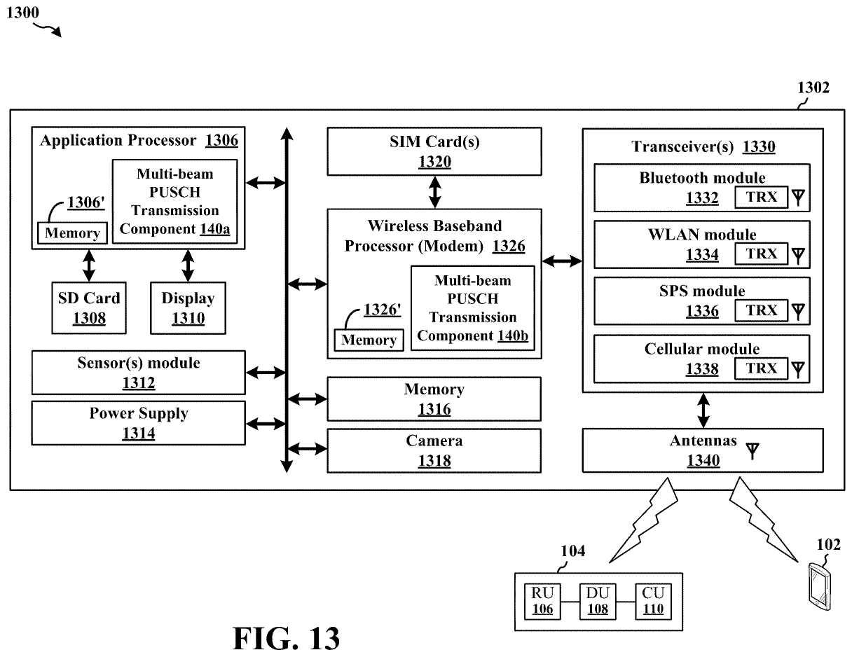

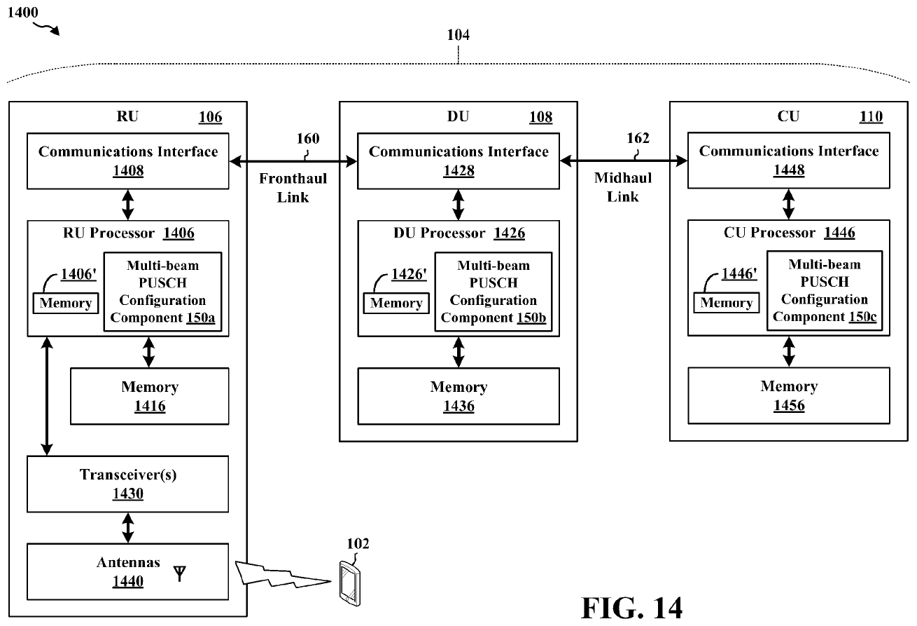

The network entity 104 receives 1212, from the UE, the multi-beam PUSCH transmission and a PT-RS based on a number of PT-RS ports and a DMRS port associated with the number of PT-RS ports. For example, referring to FIG. 4 and as illustrated in FIG. 7, the network entity 104 receives 412, from the UE 102, an SFN PUSCH and a PT-RS 202. Referring to FIG. 8 and as illustrated in FIGS. 9-10, the network entity 104 receives 812, from the UE 102, a PUSCH with the SDM scheme and a PT-RS 202. A UE apparatus 1302, as described in FIG. 13, may perform the method of flowchart 1100. The one or more network entities 104, as described in FIG. 14, may perform the method of flowchart 1200.

FIG. 13 is a diagram 1300 illustrating an example of a hardware implementation for a UE apparatus 1302. The UE apparatus 1302 may be the UE 102, a component of the UE 102, or may implement UE functionality. The UE apparatus 1302 may include an application processor 1306, which may have on-chip memory 1306′. In examples, the application processor 1306 may be coupled to a secure digital (SD) card 1308 and/or a display 1310. The application processor 1306 may also be coupled to a sensor(s) module 1312, a power supply 1314, an additional module of memory 1316, a camera 1318, and/or other related components. For example, the sensor(s) module 1312 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1302 may further include a wireless baseband processor 1326, which may be referred to as a modem. The wireless baseband processor 1326 may have on-chip memory 1326′. Along with, and similar to, the application processor 1306, the wireless baseband processor 1326 may also be coupled to the sensor(s) module 1312, the power supply 1314, the additional module of memory 1316, the camera 1318, and/or other related components. The wireless baseband processor 1326 may be additionally coupled to one or more subscriber identity module (SIM) card(s) 1320 and/or one or more transceivers 1330 (e.g., wireless RF transceivers).

Within the one or more transceivers 1330, the UE apparatus 1302 may include a Bluetooth module 1332, a WLAN module 1334, an SPS module 1336 (e.g., GNSS module), and/or a cellular module 1338. The Bluetooth module 1332, the WLAN module 1334, the SPS module 1336, and the cellular module 1338 may each include an on-chip transceiver (TRX), or in some cases, just a transmitter (TX) or just a receiver (RX). The Bluetooth module 1332, the WLAN module 1334, the SPS module 1336, and the cellular module 1338 may each include dedicated antennas and/or utilize antennas 1340 for communication with one or more other nodes. For example, the UE apparatus 1302 can communicate through the transceiver(s) 1330 via the antennas 1340 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1326 and the application processor 1306 may each include a computer-readable medium/memory 1326′, 1306′, respectively. The additional module of memory 1316 may also be considered a computer-readable medium/memory. Each computer-readable medium/memory 1326′, 1306′, 1316 may be non-transitory. The wireless baseband processor 1326 and the application processor 1306 may each be responsible for general processing, including execution of software stored on the computer-readable medium/memory 1326′, 1306′, 1316. The software, when executed by the wireless baseband processor 1326/application processor 1306, causes the wireless baseband processor 1326/application processor 1306 to perform the various functions described herein. The computer-readable medium/memory may also be used for storing data that is manipulated by the wireless baseband processor 1326/application processor 1306 when executing the software. The wireless baseband processor 1326/application processor 1306 may be a component of the UE 102. The UE apparatus 1302 may be a processor chip (e.g., modem and/or application) and include just the wireless baseband processor 1326 and/or the application processor 1306. In other examples, the UE apparatus 1302 may be the entire UE 102 and include the additional modules of the apparatus 1302.

As discussed in FIG. 1 and implemented with respect to FIG. 11, the multi-beam PUSCH transmission component 140 is configured to receive, from a network entity, a configuration for a multi-beam PUSCH transmission; and transmit, to the network entity, the multi-beam PUSCH transmission and a PT-RS based on a number of PT-RS ports and a DMRS port associated with the number of PT-RS ports. The multi-beam PUSCH transmission component 140 may be within the application processor 1306 (e.g., at 140a), the wireless baseband processor 1326 (e.g., at 140b), or both the application processor 1306 and the wireless baseband processor 1326. The multi-beam PUSCH transmission component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 14 is a diagram 1400 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1446, which may have on-chip memory 1446′. In some aspects, the CU 110 may further include an additional module of memory 1456 and/or a communications interface 1448, both of which may be coupled to the CU processor 1446. The CU 110 can communicate with the DU 108 through a midhaul link 162, such as an F1 interface between the communications interface 1448 of the CU 110 and a communications interface 1428 of the DU 108.

The DU 108 may include a DU processor 1426, which may have on-chip memory 1426′. In some aspects, the DU 108 may further include an additional module of memory 1436 and/or the communications interface 1428, both of which may be coupled to the DU processor 1426. The DU 108 can communicate with the RU 106 through a fronthaul link 160 between the communications interface 1428 of the DU 108 and a communications interface 1408 of the RU 106.

The RU 106 may include an RU processor 1406, which may have on-chip memory 1406′. In some aspects, the RU 106 may further include an additional module of memory 1416, the communications interface 1408, and one or more transceivers 1430, all of which may be coupled to the RU processor 1406. The RU 106 may further include antennas 1440, which may be coupled to the one or more transceivers 1430, such that the RU 106 can communicate through the one or more transceivers 1430 via the antennas 1440 with the UE 102.

The on-chip memory 1406′, 1426′, 1446′ and the additional modules of memory 1416, 1436, 1456 may each be considered a computer-readable medium/memory. Each computer-readable medium/memory may be non-transitory. Each of the processors 1406, 1426, 1446 is responsible for general processing, including execution of software stored on the computer-readable medium/memory. The software, when executed by the corresponding processor(s) 1406, 1426, 1446 causes the processor(s) 1406, 1426, 1446 to perform the various functions described herein. The computer-readable medium/memory may also be used for storing data that is manipulated by the processor(s) 1406, 1426, 1446 when executing the software. In examples, the multi-beam PUSCH configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 12, the multi-beam PUSCH configuration component 150 is configured to transmit, to a UE, a configuration for a multi-beam PUSCH transmission; and receive, from the UE, the multi-beam PUSCH transmission and a PT-RS based on a number of PT-RS ports and a DMRS port associated with the number of PT-RS ports. The multi-beam PUSCH configuration component 150 may be within one or more processors of the one or more network entities 104, such as the RU processor 1406 (e.g., at 150a), the DU processor 1426 (e.g., at 150b), and/or the CU processor 1446 (e.g., at 150c). The multi-beam PUSCH configuration component 150a-150c may be one or more hardware components specifically configured to carry out the stated processes/algorithm, implemented by one or more processors 1406, 1426, 1446 configured to perform the stated processes/algorithm, stored within a computer-readable medium for implementation by the one or more processors 1406, 1426, 1446, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software_shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a configuration for a multi-beam PUSCH transmission; and transmitting, to the network entity, the multi-beam PUSCH transmission and a PT-RS based on a number of PT-RS ports and a DMRS port associated with the number of PT-RS ports.

Example 2 may be combined with Example 1 and includes that the multi-beam PUSCH transmission includes one of: an SFN PUSCH transmission, or an SDM PUSCH transmission.

Example 3 may be combined with any of Examples 1-2 and further includes transmitting, to the network entity, a UE capability report indicating at least one of: a capability of the UE for the multi-beam PUSCH transmission, a maximum number of PT-RS ports associated with the multi-beam PUSCH transmission, a shared PT-RS port for the multi-beam PUSCH transmission, or different PT-RS ports for the multi-beam PUSCH transmission.

Example 4 may be combined with Example 3 and includes that the configuration for the multi-beam PUSCH transmission indicates the maximum number of PT-RS ports.

Example 5 may be combined with any of Examples 1-4 and further includes receiving, from the network entity, a triggering indication for the multi-beam PUSCH transmission indicating at least one of: one or more SRIs, multiple precoders, an order of the multiple precoders, an EPRE ratio between the multi-beam PUSCH transmission and the PT-RS, the number of PT-RS ports, a DMRS port index, or the DMRS port associated with the number of PT-RS ports.

Example 6 may be combined with Example 5 and includes that the triggering indication and the configuration for the multi-beam PUSCH transmission are included in a same message.

Example 7 may be combined with any of Examples 1-6 and includes that the transmitting further includes: transmitting PUSCH data, the PT-RS, and a DMRS using multiple beams, the number of PT-RS ports for the transmitting the PT-RS being based on at least one of: the multiple precoders or a predefined DMRS port.

Example 8 may be combined with any of Examples 1-6 and includes that the transmitting further includes: transmitting PUSCH data and a DMRS using multiple beams, and transmitting the PT-RS using a single beam, the number of PT-RS ports for the transmitting the PT-RS being based on at least one of: the multiple precoders or the one or more SRIs.

Example 9 may be combined with any of Examples 1-6 and includes that the transmitting further includes: transmitting PUSCH data and a DMRS from different layers for multiple SRIs and multiple precoders, and transmitting the PT-RS from a single PT-RS port for a single SRI and a single precoder.

Example 10 may be combined with any of Examples 1-6 and includes that the transmitting further includes: transmitting PUSCH data and a DMRS from different layers for multiple SRIs and multiple precoders, and transmitting the PT-RS from multiple PT-RS ports for the multiple SRIs and the multiple precoders.

Example 11 may be combined with any of Examples 1-6 and includes that the transmitting further includes: transmitting PUSCH data and a DMRS from different layers for multiple SRIs and multiple precoders, and transmitting the PT-RS from a single PT-RS port for the multiple SRIs and the multiple precoders.

Example 12 may be combined with any of Examples 1-11 and includes that the multi-beam PUSCH transmission includes a first beam associated with a first TCI and a second beam associated with a second TCI, the first beam being different from the second beam.

Example 13 is a method of wireless communication at a network entity, including: transmitting, to a UE, a configuration for a multi-beam PUSCH transmission; and receiving, from the UE, the multi-beam PUSCH transmission and a PT-RS based on a number of PT-RS ports and a DMRS port associated with the number of PT-RS ports.

Example 14 may be combined with Example 13 and includes that the multi-beam PUSCH transmission includes one of: an SFN PUSCH transmission, or an SDM PUSCH transmission.

Example 15 may be combined with any of Examples 13-14 and further includes receiving, from the UE, a UE capability report indicating at least one of: a capability of the UE for the multi-beam PUSCH transmission, a maximum number of PT-RS ports associated with the multi-beam PUSCH transmission, a shared PT-RS port for the multi-beam PUSCH transmission, or different PT-RS ports for the multi-beam PUSCH transmission.

Example 16 may be combined with Example 15 and includes that the configuration for the multi-beam PUSCH transmission indicates the maximum number of PT-RS ports.

Example 17 may be combined with any of Examples 13-16 and further includes transmitting, to the UE, a triggering indication for the multi-beam PUSCH transmission indicating at least one of: one or more SRIs, multiple precoders, an order of the multiple precoders, an EPRE ratio between the multi-beam PUSCH transmission and the PT-RS, the number of PT-RS ports, a DMRS port index, or the DMRS port associated with the number of PT-RS ports.

Example 18 may be combined with Example 17 and includes that the triggering indication and the configuration for the multi-beam PUSCH transmission are included in a same message.

Example 19 may be combined with any of Examples 13-18 and includes that the receiving further includes: receiving PUSCH data, the PT-RS, and a DMRS using multiple beams, the number of PT-RS ports for the receiving the PT-RS being based on at least one of: the multiple precoders or a predefined DMRS port.

Example 20 may be combined with any of Examples 13-18 and includes that the receiving further includes: receiving PUSCH data and a DMRS using multiple beams, and receiving the PT-RS using a single beam, the number of PT-RS ports for the receiving the PT-RS being based on at least one of: the multiple precoders or the one or more SRIs.

Example 21 may be combined with any of Examples 13-18 and includes that the receiving further includes: receiving PUSCH data and a DMRS from different layers for multiple SRIs and multiple precoders, and receiving the PT-RS from a single PT-RS port for a single SRI and a single precoder.

Example 22 may be combined with any of Examples 13-18 and includes that the receiving further includes: receiving PUSCH data and a DMRS from different layers for multiple SRIs and multiple precoders, and receiving the PT-RS from multiple PT-RS ports for the multiple SRIs and the multiple precoders.

Example 23 may be combined with any of Examples 13-18 and includes that the receiving further includes: receiving PUSCH data and a DMRS from different layers for multiple SRIs and multiple precoders, and receiving the PT-RS from a single PT-RS port for the multiple SRIs and the multiple precoders.

Example 24 may be combined with any of Examples 13-23 and includes that the multi-beam PUSCH transmission includes a first beam associated with a first TCI and a second beam associated with a second TCI, the first beam being different from the second beam.

Example 25 is an apparatus for wireless communication for implementing a method as in any of examples 1-24.

Example 26 is an apparatus for wireless communication including means for implementing a method as in any of examples 1-24.

Example 27 is a non-transitory computer-readable medium storing computer executable code, the code when executed by a processor causes the processor to implement a method as in any of examples 1-24.

What is claimed is:

1. A method of wireless communication at a user equipment (UE), comprising:
receiving, from a network entity, a configuration for a multi-beam physical uplink shared channel (PUSCH) transmission including at least one of a single frequency network (SFN) PUSCH transmission or a spatial-domain multiplexing (SDM) PUSCH transmission; and
transmitting, to the network entity, the multi-beam PUSCH transmission and a phase tracking reference signal (PT-RS) based on a number of PT-RS ports and a demodulation reference signal (DMRS) port associated with a PT-RS port corresponding to the number of PT-RS ports.

2. The method of claim 1, wherein the transmitting further comprises:
transmitting PUSCH data and a DMRS using multiple beams; and
transmitting the PT-RS using multiple beams based on the number of PT-RS ports determined from at least one of multiple precoders or a predefined DMRS port, or transmitting the PT-RS using a single beam based the number of PT-RS ports determined from at least one of the multiple precoders or one or more sounding reference signal (SRS) resource indicators (SRIs).

3. The method of claim 1, further comprising:
transmitting, to the network entity, a UE capability report indicating at least one of:
a capability of the UE for the multi-beam PUSCH transmission,
a maximum number of PT-RS ports associated with the multi-beam PUSCH transmission,
a shared PT-RS port for the multi-beam PUSCH transmission, or
different PT-RS ports for the multi-beam PUSCH transmission.

4. The method of claim 3, wherein the configuration for the multi-beam PUSCH transmission indicates the maximum number of PT-RS ports.

5. The method of claim 1, further comprising:
receiving, from the network entity, a triggering indication for the multi-beam PUSCH transmission indicating at least one of:
one or more sounding reference signal (SRS) resource indicators (SRIs), or
an energy per resource element (EPRE) ratio between the multi-beam PUSCH transmission and the PT-RS.

6. The method of claim 5, wherein the triggering indication and the configuration for the multi-beam PUSCH transmission are included in a same message.

7. The method of claim 1, wherein the multi-beam PUSCH transmission is configured as a codebook-based SFN PUSCH transmission, the method further comprising:
determining the number of PT-RS ports based on an indicated precoder from a plurality of precoders.

8. The method of claim 1, wherein the multi-beam PUSCH transmission is configured as a non-codebook-based SFN PUSCH transmission, the method further comprising:
determining the number of PT-RS ports based on one or more indicated sounding reference signal (SRS) resources from an SRS resource set.

9. The method of claim 1, wherein the multi-beam PUSCH transmission is configured as the SDM PUSCH transmission, the method further comprising:
determining the number of PT-RS ports based on a configured maximum number of PT-RS ports for the SDM PUSCH transmission.

10. The method of claim 9, wherein the maximum number of PT-RS ports for the SDM PUSCH transmission is a two port uplink PT-RS scheme, the method further comprising:
receiving an indication of an association between the PT-RS port and the DMRS port for the SDM PUSCH transmission with two sounding reference signal indicators (SRIs).

11. The method of claim 10, wherein the two port uplink PT-RS scheme comprises a first PT-RS port corresponding to a first beam and a second PT-RS port corresponding to a second beam, wherein the indication of the association between the PT-RS port and the DMRS port indicates a DMRS port for the first beam associated with the first PT-RS port based on a first SRI, and a DMRS port for the second beam associated with the second PT-RS port based on a second SRI.

12. The method of claim 1, wherein the multi-beam PUSCH transmission includes a first beam associated with a first transmission configuration indicator (TCI) and a second beam associated with a second TCI, the first beam being different from the second beam.

13. A method of wireless communication at a network entity, comprising:
transmitting, to a user equipment (UE), a configuration for a multi-beam physical uplink shared channel (PUSCH) transmission including at least one of a single frequency network (SFN) PUSCH transmission or a spatial-domain multiplexing (SDM) PUSCH transmission; and
receiving, from the UE, the multi-beam PUSCH transmission and a phase tracking reference signal (PT-RS) based on a number of PT-RS ports and a demodulation reference signal (DMRS) port associated with a PT-RS port corresponding to the number of PT-RS ports.

14. The method of claim 13, further comprising:
transmitting, to the UE, a triggering indication for the multi-beam PUSCH transmission indicating at least one of:
one or more sounding reference signal (SRS) resource indicators (SRIs), or
an energy per resource element (EPRE) ratio between the multi-beam PUSCH transmission and the PT-RS.

15. An apparatus for wireless communication at a user equipment (UE), comprising:
a memory,
a transceiver, and
a processor coupled to the memory and the transceiver, the processor configured to:
receive, from a network entity, a configuration for a multi-beam physical uplink shared channel (PUSCH) transmission including at least one of a single frequency network (SFN) PUSCH transmission or a spatial-domain multiplexing (SDM) PUSCH transmission; and
transmit, to the network entity, the multi-beam PUSCH transmission and a phase tracking reference signal (PT-RS) based on a number of PT-RS ports and a demodulation reference signal (DMRS) port associated with a PT-RS port corresponding to the number of PT-RS ports.

16. The apparatus of claim 15, wherein the multi-beam PUSCH transmission is configured as a codebook-based SFN PUSCH transmission, the processor further configured to:
determine the number of PT-RS ports based on an indicated precoder from a plurality of precoders.

17. The apparatus of claim 15, wherein the multi-beam PUSCH transmission is configured as a non-codebook-based SFN PUSCH transmission, the processor further configured to:
determine the number of PT-RS ports based on one or more indicated sounding reference signal (SRS) resources from an SRS resource set.

18. The apparatus of claim 15, wherein the multi-beam PUSCH transmission is configured as the SDM PUSCH transmission, the processor further configured to:
determine the number of PT-RS ports based on a configured maximum number of PT-RS ports for the SDM PUSCH transmission.

19. The apparatus of claim 18, wherein the maximum number of PT-RS ports for the SDM PUSCH transmission is a two port uplink PT-RS scheme, the processor further configured to:
receive an indication of an association between the PT-RS port and the DMRS port for the SDM PUSCH transmission with two sounding reference signal indicators (SRIs).

20. The apparatus of claim 19, wherein the two port uplink PT-RS scheme comprises a first PT-RS port corresponding to a first beam and a second PT-RS port corresponding to a second beam, wherein the indication of the association between the PT-RS port and the DMRS port indicates a DMRS port for the first beam associated with the first PT-RS port based on a first SRI, and a DMRS port for the second beam associated with the second PT-RS port based on a second SRI.
